(19) United States
(12) Patent Application Publication
(10) Pub. No.: US 2019/0011270 A1
(43) Pub. Date: Jan. 10, 2019

(54) Method for Obtaining an Orientation of at Least One Section of a Felled Tree and Forestry System for Obtaining an Orientation of at Least One Section of a Felled Tree

(71) Applicant: Andreas Stihl AG & Co. KG, Waiblingen (DE)

(72) Inventors: Benjamin FREY, Berglen (DE); Dirk JAEGER, Hatzfeld (DE); Harald MANG, Winnenden (DE); Bettina MEIER, Tuebingen (DE); Michael REINERT, Rudersberg (DE)

(21) Appl. No.: 16/026,803

(22) Filed: Jul. 3, 2018

(30) Foreign Application Priority Data
Jul. 4, 2017 (EP) 17179677.4

(51) Int. Cl. G01C 21/34; A01G 23/095

(52) U.S. Cl. CPC G01C 21/3407; B27B 17/00; A01G 23/095

(57) ABSTRACT

A method obtains an orientation of at least one section of a felled tree. The method includes the steps of: treating the at least one section of the felled tree; identifying an alignment and/or a position during the treatment; obtaining orientation information related to the orientation of the at least one section of the felled tree based on the identified alignment and/or the identified position; and outputting the obtained orientation information.

### CROSS REFERENCE TO RELATED APPLICATIONS

This application claims priority under 35 U.S.C. § 119 from European Patent Application No. EP 17179677.4, filed Jul. 4, 2017, the entire disclosure of which is herein expressly incorporated by reference.

### BACKGROUND AND SUMMARY OF THE INVENTION

The invention relates to a method for obtaining an orientation of at least one section of a felled tree and a forestry system for obtaining an orientation of at least one section of a felled tree.

The invention is based on the problem of providing a method for obtaining an orientation of at least one section of a felled tree and a forestry system for obtaining an orientation of at least one section of a felled tree, each of which are user-friendly and/or facilitate simple further treatment of the section.

The invention solves this problem by providing a method and forestry system for obtaining an orientation of at least one section of a felled tree in accordance with embodiments of the invention. Advantageous developments and/or configurations of the invention are described and claimed herein.

The method according to the invention, in particular the automatic method according to the invention, for obtaining an orientation of at least one section of a felled tree includes the steps of: a) treating the at least one section of the felled tree; b) identifying, in particular automatically identifying, an alignment and/or a position during the treatment; c) obtaining, in particular automatically obtaining, orientation information related to the orientation of the at least one section of the felled tree based on the identified alignment and/or the identified position; and d) outputting, in particular automatically outputting, the obtained orientation information.

The method facilitates treating the section and, besides, obtaining the orientation information. Expressed differently: the alignment and/or the position and/or the orientation information need not be identified and/or obtained separately, in particular separately in time, from the treatment. This can save time for a forestry worker. In addition or as an alternative thereto, the method allows the forestry worker and/or a retrieval vehicle for retrieving the section on the basis of the output orientation information to simply treat the section further. Consequently, a maximum economic gain can be obtained with the section.

In particular, the at least one section of the felled tree can be treated in step a) by a removal of branches, to the extent these are present, from the section and/or by severing the section. The removal of branches can be referred to as debranching. In particular, the at least one section of the tree can be lying down. The orientation of the section can correspond to a longitudinal axis of the section.

The alignment can include or be a cardinal direction or a value and/or a magnitude of the cardinal direction. The position can include or be coordinates or a value and/or a magnitude of the coordinates. In particular, the alignment can be an alignment of the forestry worker treating the section. The position can be a position of the forestry worker treating the section.

The identified alignment and/or the identified position can be transmitted, in particular in a wireless manner, in particular to a database and/or a network and/or a hub and/or a cloud and/or the like, in particular to the Internet. In addition or as an alternative thereto, the obtained orientation information can be transmitted.

The orientation information can be output optically and/or acoustically and/or haptically. In particular, the optical output can include displaying. The haptic output can include vibrating.

Step c) can be carried out at the same time as step b) and/or after the latter in time. Step d) can be carried out at the same time as step c) and/or after the latter in time.

In a development of the invention, the at least one section of the felled tree is treated using a forestry treatment apparatus in step a). The alignment and/or the position of the forestry treatment apparatus are/is identified in step b).

In a configuration of the invention, the method includes the step: identifying, in particular automatically identifying, an operation of the forestry treatment apparatus, in particular of an operation device of the forestry treatment apparatus. In step b), the alignment and/or the position is/are identified as a function of the identified operation, particularly only in that case. Consequently, the alignment and/or the position can be relatively meaningful. In particular, the alignment and/or the position can be identified at the same time as identifying the operation or immediately after the identified operation in time. In other words: the orientation information can be obtained on the basis of the identified alignment and/or the identified position as a function of the identified operation in step c).

In a development of the invention, a plurality of positions are identified in step b). The orientation information related to the orientation of the at least one section of the felled tree is obtained based on the identified positions in step c). In particular, the plurality of positions can be or include a plurality of distance positions or debranching positions and/or a plurality of sever positions or split cut positions.

In a configuration of the invention, the orientation information is obtained using a regression analysis, in particular a linear regression analysis, of the identified positions in step c). This can facilitate obtaining the orientation information relatively accurately. Phrased differently: the orientation can be described by a line, in particular a straight line.

In a development of the invention, the orientation information is a cardinal direction of the at least one section of the felled tree. In addition or as an alternative thereto, the orientation information is route guidance to a collection location of the at least one section of the felled tree. This facilitates simple retrieval of the section, in particular from a forest, by the forestry worker and/or a retrieval vehicle. In particular, the cardinal direction can include or be a value and/or a magnitude. The collection position can include or be coordinates or a value and/or a magnitude of the coordinates. Additionally, the orientation information can include the position of the section. The cardinal direction can be entered into a map, in particular a digital map. The map can contain a path network, in particular logging trails. The retrieval vehicle can be a logging vehicle and/or a towing crane and/or a tractor and/or a forwarder and/or a harvester.

Moreover, the invention relates to a forestry system for obtaining the orientation of the at least one section of the felled tree. In particular, the forestry system can be embodied to carry out the above-described method. The forestry system according to the invention comprises a forestry treatment apparatus, an identification device, an obtaining device and an output device. The forestry treatment apparatus is embodied to treat the at least one section of the felled tree. The identification device is embodied to identify the alignment and/or position of the forestry treatment apparatus, in particular during the treatment by means of the forestry treatment apparatus. The obtaining device is embodied to obtain the orientation information related to the orientation of the at least one section of the felled tree based on the identified alignment and/or the identified position. The output device is embodied to output the obtained orientation information.

The forestry system can facilitate the same advantages as the above-described method.

In particular, the forestry treatment apparatus can be embodied as a hand-held forestry treatment apparatus. Hand-held forestry treatment apparatus can mean that the forestry treatment apparatus may have a maximum mass of 50 kilograms (kg), in particular 20 kg, in particular 10 kg.

The identification device can be arranged at the forestry treatment apparatus, in particular integrated into the forestry treatment apparatus.

The obtaining device can comprise or be a processor, in particular a CPU.

The output device can comprise or be a display and/or a sound producer and/or a vibrating device.

Additionally, the forestry system can have at least one transmission device that can be embodied to transmit the identified alignment and/or the identified position and/or the obtained orientation information. The at least one transmission device can be embodied to transmit from the identification device and/or to the obtaining device and/or from the obtaining device and/or to the output device. In particular, the at least one transmission device can comprise or be a UMTS, WLAN and/or Bluetooth transmission device or a transmission device based on any other technology.

In a development of the invention, the forestry treatment apparatus comprises a cutting tool or is the latter. The cutting tool is embodied to remove branches from the at least one section and/or to sever the section. The cutting tool can comprise or be a saw, in particular a power saw and/or a chainsaw.

In a development of the invention, the forestry treatment apparatus comprises the operating device. The forestry system is embodied to identify an operation of the operating device. The identification device is embodied to identify the alignment and/or the position as a function of the identified operation. In other words: the obtaining device can be embodied to obtain the orientation information based on the identified alignment and/or the identified position as a function of the identified operation. In particular, the operating device can be embodied to operate the forestry treatment apparatus or it may facilitate a treatment by means of the forestry treatment apparatus. Phrased differently: if the operating device is not operated, treatment by means of the forestry treatment apparatus cannot be possible. The operating device can comprise or be a throttle or throttle stop and/or a chain brake.

In a development of the invention, the identification device comprises a compass and/or a local position determination device and/or a satellite position determination device. In particular, the alignment can be identified by means of the compass. The position can be identified by means of the local position determination device and/or the satellite position determination device. The compass can be embodied as an electric or digital compass. The local position determination device can be based on one or more different technologies, such as distance measurements to nodes, optical signals, radio waves, magnetic fields, acoustic signals, ultra-wideband, Bluetooth, WLAN, ultrasound and/or RFID. The local position determination device can also be referred to as local positioning system. The satellite position determination device can be embodied for one or more satellite position determination systems such as NAVSTAR GPS, GLONASS, Galileo and/or BeiDou. In addition or as an alternative thereto, the satellite position determination device can be embodied as an RTK (real-time kinematic) satellite position determination device and/or as a differential satellite position determination device.

In a development of the invention, the output device comprises a route guidance system. The route guidance system is embodied to output the route guidance to the collection location of the at least one section of the felled tree. In particular, the route guidance system can be referred to as a navigation system. The route guidance system can comprise a compass and/or a local position determination device and/or a satellite position determination device.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a flowchart of an exemplary method according to the invention.

FIG. 2 is a top view of a forestry system according to an embodiment of the invention having a forestry treatment apparatus, during a treatment of at least one section of a felled tree.

FIG. 3 is a side view of the forestry treatment apparatus of FIG. 2.

FIG. 4 is a further top view of the forestry system of FIG. 2 after a treatment.

### DETAILED DESCRIPTION OF THE DRAWINGS

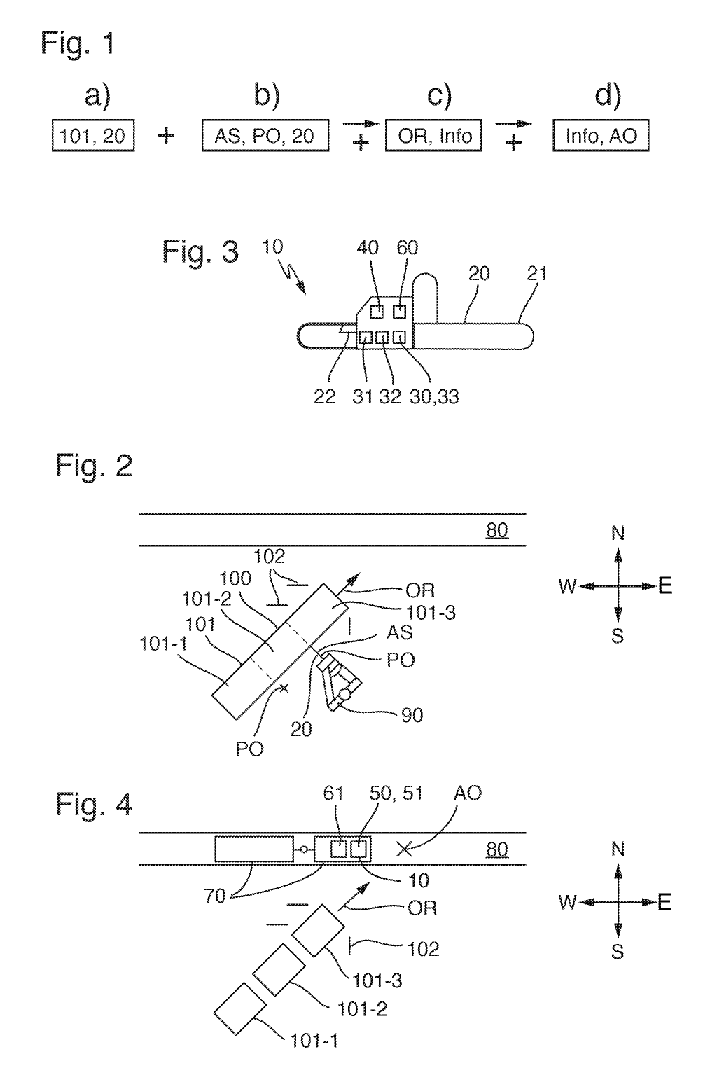

FIG. 1 shows a method for obtaining an orientation OR of at least one section 101 of a felled tree 100. The method includes the steps of: a) treating the at least one section 101 of the felled tree 100; b) identifying an alignment AS and a position PO during the treatment; c) obtaining orientation information Info related to the orientation OR of the at least one section 101 of the felled tree 100 based on the identified alignment AS and the identified position PO; and d) outputting the obtained orientation information Info. In alternative exemplary embodiments, either the alignment or the position can be identified in step b). Further, the orientation information can be obtained on the basis of either the identified alignment or the identified position in step c) in alternative exemplary embodiments.

FIGS. 2 to 4 show a forestry system 10 for obtaining the orientation OR of the at least one section 101 of the felled tree 100. In particular, the forestry system 10 is embodied to carry out the above-described method. The forestry system 10 comprises a forestry treatment apparatus 20, an identification device 30, an obtaining device 40 and an output device 50. The forestry treatment apparatus 20 is embodied to treat the at least one section 101 of the felled tree 100. The identification device 30 is embodied to identify the alignment AS and/or position PO of the forestry treatment apparatus 20. The obtaining device 40 is embodied to obtain the orientation information Info related to the orientation OR of the at least one section 101 of the felled tree 100 based on the identified alignment AS and/or the identified position PO. The output device 50 is embodied to output the obtained orientation information Info. In alternative exemplary embodiments, the identification device can be embodied to identify either the alignment or the position. Further, the obtaining device can be embodied to obtain the orientation information on the basis of either the identified alignment or the identified position in alternative exemplary embodiments. In the shown exemplary embodiment, the identification device 30 is arranged at the forestry treatment apparatus 20, in particular integrated into the forestry treatment apparatus 20. In alternative exemplary embodiments, the identification device can be arranged elsewhere, in particular on a forestry worker.

Accordingly, the at least one section 101 of the felled tree 100 is treated in step a) by means of the forestry treatment apparatus 20. The alignment AS and the position PO of the forestry treatment apparatus 20 are identified in step b).

In detail, the forestry treatment apparatus 20 comprises an operating device 22 in the form of a throttle, as can be identified in FIG. 3. The forestry system 10 is embodied to identify an operation of the operating device 22. The identification device 30 is embodied to identify the alignment AS and the position PO as a function of the identified operation.

Accordingly, the method includes the step of: identifying the operation of the forestry treatment apparatus 20. The alignment AS and the position PO are identified in step b) as a function of the identified operation.

Moreover, the forestry treatment apparatus 20 is a cutting tool 21 in the form of a saw, in particular a motor-driven chainsaw. The cutting tool 21 is embodied to remove branches 102 from the at least one section 101 and to sever the section 101. In alternative exemplary embodiments, the cutting tool can be embodied either to remove branches from the section or to sever the section.

Moreover, the identification device 30 comprises a compass 31 and a local position determination device 32 and a satellite position determination device 33. In alternative exemplary embodiments, the identification device can comprise the compass or the local position determination device or the satellite position determination device.

In the exemplary embodiment shown in FIG. 2, the forestry worker 90 has already removed the branches 102 from the section 101 by means of the forestry treatment apparatus 20. The forestry worker 90 should sever the section 101 into at least three subsections 101-1, 101-2, 101-3 by means of the forestry treatment apparatus 20, in particular by split cuts, as indicated by dashed lines in FIG. 2.

The alignment AS of the forestry treatment apparatus 20 is identified while severing the section 101 into the subsections 101-1, 101-2, 101-3, in particular by means of the compass 31. In detail, the cutting tool 21 in the form of the saw has a guide rail or a chain blade. The cutting tool 21 is aligned during the severing in such a way that a plane of the guide rail or a plane of the split cuts extends perpendicular to the orientation OR of the section 101. In the shown exemplary embodiment, the orientation OR in FIGS. 2 and 4 is top right or in the north-east cardinal direction.

In the shown exemplary embodiment, the forestry system 10 is embodied to allow the forestry worker 90 to communicate or select severing or a split cut to be carried out, in particular currently.

Moreover, a plurality of positions PO of the forestry treatment apparatus 20 are identified during the severing of the section 101 into the subsections 101-1, 101-2, 101-3, in particular by means of the local position determination device 32 and/or of the satellite position determination device 33. In detail, the plurality of positions PO, in particular of the split cuts, are along the section 101 with the orientation OR.

Accordingly, the orientation information Info relating to the orientation OR of the at least one section 101 of the felled tree 100 is obtained based on the identified positions PO, in particular by means of the obtaining device 40, in step c). In detail, the orientation information Info is obtained in step c) by means of a linear regression analysis of the identified positions PO.

In the shown exemplary embodiment, the obtaining device 40 is arranged at the forestry treatment apparatus 20, in particular integrated into the forestry treatment apparatus 20. In alternative exemplary embodiments, the obtaining device can be arranged elsewhere, in particular on the forestry worker or at, or in, a retrieval vehicle.

Moreover, the orientation information Info in the shown exemplary embodiment is a route guidance to a collection location AO, in particular on a logging trail 80, of the at least one section 101, in particular the subsections 101-1, 101-2, 101-3, of the felled tree 100. In alternative exemplary embodiments, the orientation information can be, additionally or alternatively, a cardinal direction of the at least one section of the felled tree.

Moreover, the output device 50 has a route guidance system 51. The route guidance system 51 is embodied to output the route guidance to the collection location AO of the at least one section 101 of the felled tree 100. In the shown exemplary embodiment, the output device 50 or the route guidance system 51 thereof is arranged at the retrieval vehicle 70 for retrieving the section 101, in particular integrated into the retrieval vehicle 70. In alternative exemplary embodiments, the output device can be arranged elsewhere, in particular at, or in, the forestry treatment apparatus or on the forestry worker.

The output device 50 or the route guidance system 51 thereof has a display (not illustrated) and a sound producer (not illustrated). In alternative exemplary embodiments, the output device or the route guidance system thereof can have either the display or the sound producer. Furthermore, the output device or the route guidance system thereof, additionally or alternatively, may have a vibrating device in alternative exemplary embodiments.

Accordingly, the orientation information Info is output optically, in particular by means of the display, and acoustically, in particular by means of the sound producer, in step d), in particular for a driver of the retrieval vehicle 70. In alternative exemplary embodiments, the orientation information can be output either optically or acoustically. Furthermore, the orientation information, additionally or alternatively, can be output haptically in alternative exemplary embodiments, in particular by means of a vibrating device.

Further, the forestry system 10 comprises at least one transmission device 60, 61, wherein two transmission devices 60, 61 are in the shown exemplary embodiment. In alternative exemplary embodiments, the forestry system can comprise only a single transmission device or at least three transmission devices. One of the two transmission devices 60 is arranged at the forestry treatment apparatus 20, in particular integrated into the forestry treatment apparatus 20. The other of the two transmission devices 61 is arranged at the retrieval vehicle 70, in particular integrated into the retrieval vehicle 70. In alternative exemplary embodiments, the at least one transmission device can be arranged elsewhere, in particular on the forestry worker.

The transmission devices 60, 61 are embodied to interact with one another and to transmit the obtained orientation information Info. In alternative exemplary embodiments, the transmission devices, additionally or alternatively, can be embodied to transmit the identified alignment and/or the identified position.

Accordingly, the obtained orientation information Info is transmitted, in particular from the obtaining device 40 to the output device 50. In alternative exemplary embodiments, the identified alignment and/or the identified position can be additionally transmitted, in particular from the identification device to the obtaining device.

As the shown exemplary embodiments, explained above, make clear, the invention provides an advantageous method for obtaining an orientation of at least one section of a felled tree and an advantageous forestry system for obtaining an orientation of at least one section of a felled tree, each of which are user-friendly and facilitate simple further treatment of the section.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for obtaining an orientation of at least one section of a felled tree, the method comprising the steps of:
a) treating the at least one section of the felled tree;
b) identifying an alignment and/or a position during the treatment;
c) obtaining orientation information related to the orientation of the at least one section of the felled tree based on the identified alignment and/or the identified position; and
d) outputting the obtained orientation information.

2. The method according to claim 1, wherein
in step a), the at least one section of the felled tree is treated using a forestry treatment apparatus, and
in step b), the alignment and/or the position of the forestry treatment apparatus is identified.

3. The method according to claim 2, further comprising the step of:
identifying an operation of the forestry treatment apparatus, wherein
in step b), the alignment and/or the position is identified as a function of the identified operation.

4. The method according to claim 1, wherein
in step b), a plurality of positions are identified, and
in step c), the orientation information related to the orientation of the at least one section of the felled tree is obtained based on the plurality of identified positions.

5. The method according to claim 4, wherein
in step c), the orientation information is obtained using a regression analysis of the identified positions.

6. The method according to claim 1, wherein
the orientation information is a cardinal direction of the at least one section of the felled tree, or
the orientation information is a route guidance to a collection location of the at least one section of the felled tree.

7. A forestry system for obtaining an orientation of at least one section of a felled tree, comprising:
a forestry treatment apparatus configured to treat the at least one section of the felled tree;
an identification device configured to identify an alignment and/or a position of the forestry treatment apparatus;
an obtaining device configured to obtain orientation information related to the orientation of the at least one section of the felled tree based on the identified alignment and/or the identified position; and
an output device configured to output the obtained orientation information.

8. The forestry system according to claim 7, wherein
the forestry treatment apparatus includes a cutting tool configured to remove branches from the at least one section and/or to sever said section.

9. The forestry system according to claim 7, wherein
the forestry treatment apparatus includes an operating device,
the forestry system is configured to identify an operation of the operating device, and
the identification device is configured to identify the alignment and/or the position as a function of the identified operation.

10. The forestry system according to claim 7, wherein
the identification device includes a compass, a local position determination device, and/or a satellite position determination device.

11. The forestry system according to claim 7, wherein
the output device includes a route guidance system configured to output a route guidance to a collection location of the at least one section of the felled tree.
